(19) United States
(12) Patent Application Publication
(10) Pub. No.: US 2005/0284880 A1
(43) Pub. Date: Dec. 29, 2005

(54) Vending machine

(75) Inventor: Mitsuyuki Kenmochi, Isesaki-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Sanden Corporation, Isesaki-shi (JP)

(21) Appl. No.: 11/140,982

(22) Filed: Jun. 1, 2005

(30) Foreign Application Priority Data
Jun. 23, 2004 (JP) 2004/184561

(51) Int. Cl. G07F 11/16; B65H 1/08

(52) U.S. Cl. 221/279; 221/198

(57) ABSTRACT

A vending machine has commodity storing devices for sale use, commodity storing devices for replenishment use and a commodity transferring device. This vending machine performs usual sale operation by delivering a commodity in one of the commodity storing devices for sale use by means of the commodity transferring device to a commodity outlet, and replenishes one of the commodity storing devices with at least one commodity from one of the commodity storing devices for replenishment use by means of the commodity transferring device.

### BACKGROUND OF THE INVENTION

1. Field of the Invention

The present invention relates to a vending machine for storing and selling commodities, and more particularly to a vending machine which makes stored commodities and selling actions visible from outside through a transparent panel.

2. Description of the Related Art

A conventional vending machine of this kind usually has a transparent panel disposed on the front side of the vending machine, a plurality of commodity storing devices arranged in a prescribed form in the vending machine, and a commodity transferring device for receiving a commodity from one of the commodity storing devices and delivering the commodity to a commodity outlet.

The commodity storing devices each have a belt which permit loading of commodities in tandem and can move in the back-and-forth direction. The commodity transferring device has a drive mechanism capable of moving the belt of one of the commodity storing devices in the back-and-forth direction, a commodity bucket provided with a belt which permits loading of a commodity and can move in the back-and-forth direction, a drive mechanism capable of moving the belt of the commodity bucket in the back-and-forth direction, and a drive mechanism capable of moving the commodity bucket in the up-and-down direction and back-and-forth direction.

A buyer can visually recognize commodities stored in the commodity storing devices through the transparent panel from outside. Thus, the buyer can recognize through the transparent panel from outside a sale action including a movement which the commodity bucket moves toward a prescribed commodity storing device, a movement which a foremost commodity on the belt of the prescribed commodity storing device is delivered into the commodity bucket, and a movement which the commodity bucket loaded with the commodity moves toward the commodity outlet, and so on.

In this vending machine, which permits visually recognition of stored commodities through the transparent panel from outside, when the storage number of commodities decreases with the progress of sale, the visual impression which the prospective buyer gets becomes poorer than when enough commodities are stored in the vending machine and the buying inclination of the prospective buyer declines.

Although the replenishment of commodities to the vending machine is performed by manual work of the operator or the like, it is difficult to enable the replenishment to adequately catch up with the sale of commodities. If the replenishment fails to catch up, the stored commodities will unusually decrease and become sold out.

### SUMMARY OF THE INVENTION

An object of the present invention is to provide a vending machine capable of being automatically replenished with commodities without relying on manual work.

In order to achieve the above object, the vending machine according to the present invention comprises: first commodity storing devices for sale use arranged in the vending machine; second commodity storing devices for replenishment use arranged in the vending machine; a commodity transferring device arranged in the vending machine; a transparent panel arranged on the front face of the vending machine; a commodity outlet arranged in the front face of the vending machine; sale control means for delivering a commodity from one of the first commodity storing devices to the commodity outlet by the commodity transferring device; and replenishment control means for replenishing at least one of the first commodity storing devices with at least one commodity from at least one of the second commodity storing devices by the commodity transferring device.

In this vending machine, the first commodity storing devices can be automatically replenished, without relying on manual work, with commodities from the second commodity storing devices by means of the commodity transferring device for regular use in selling. Therefore, it is possible to have commodity replenishment follow commodity sale, thereby to prevent the decreased number of commodities stored in the first commodity storing devices from deteriorating the impression that the prospective buyer would receive.

### BRIEF DESCRIPTION OF THE DRAWINGS

FIG. 1 shows a front view of a vending machine, which is a preferred embodiment of the present invention;

FIG. 2 shows a front view of a cabinet, revealing the internal mechanism of the vending machine shown in FIG. 1;

FIG. 3(A) shows a front view of a commodity storing device shown in FIG. 1 and FIG. 2;

FIG. 3(B) shows a section along line a1-a1 in FIG. 3(A);

FIG. 4(A) shows a front view of a commodity bucket shown in FIG. 1 and FIG. 2;

FIG. 4(B) shows a section along line a2-a2 in FIG. 4(A);

FIG. 4(C) illustrates an operation of the commodity bucket;

FIG. 5 shows a configuration of a control system;

FIG. 6 is a flow chart of a commodity sale control;

FIG. 7 illustrates commodity selling actions;

FIG. 8 illustrates commodity selling actions following FIG. 7;

FIG. 9 illustrates commodity selling actions following FIG. 8;

FIG. 10 illustrates commodity selling actions following FIG. 9;

FIG. 11 illustrates commodity selling actions following FIG. 10;

FIG. 12 illustrates commodity selling actions following FIG. 11;

FIG. 13 is a flow chart of a commodity replenishment control;

FIG. 14 illustrates commodity replenishing actions;

FIG. 15 illustrates commodity replenishing actions following FIG. 14;

FIG. 16 illustrates commodity replenishing actions following FIG. 15;

FIG. 17 illustrates commodity replenishing actions following FIG. 16;

FIG. 18 illustrates commodity replenishing actions following FIG. 17;

FIG. 19 illustrates commodity replenishing actions exemplifying a variation of commodity replenishing method;

FIG. 20 illustrates commodity replenishing actions following FIG. 19; and

FIG. 21 illustrates commodity replenishing actions following FIG. 20.

### DESCRIPTION OF THE PREFERRED EMBODIMENTS

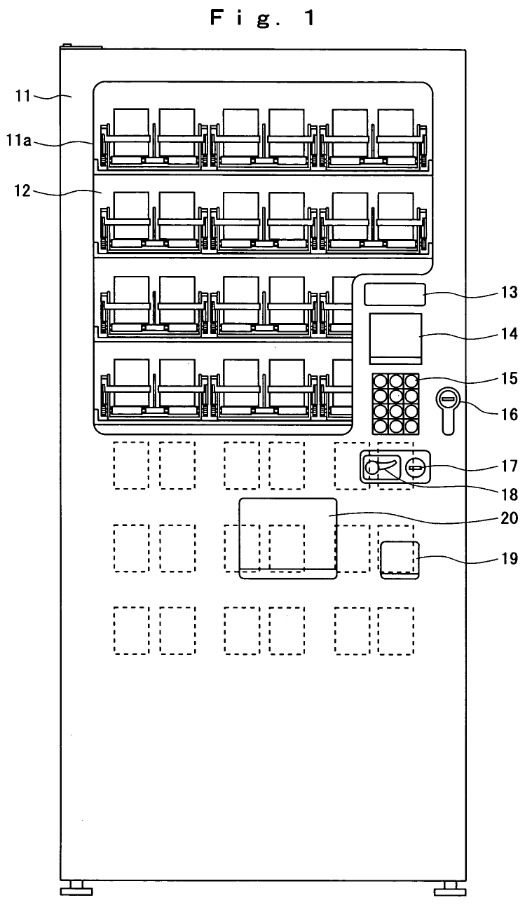

FIG. 1 to FIG. 18 show a preferred embodiment of the present invention.

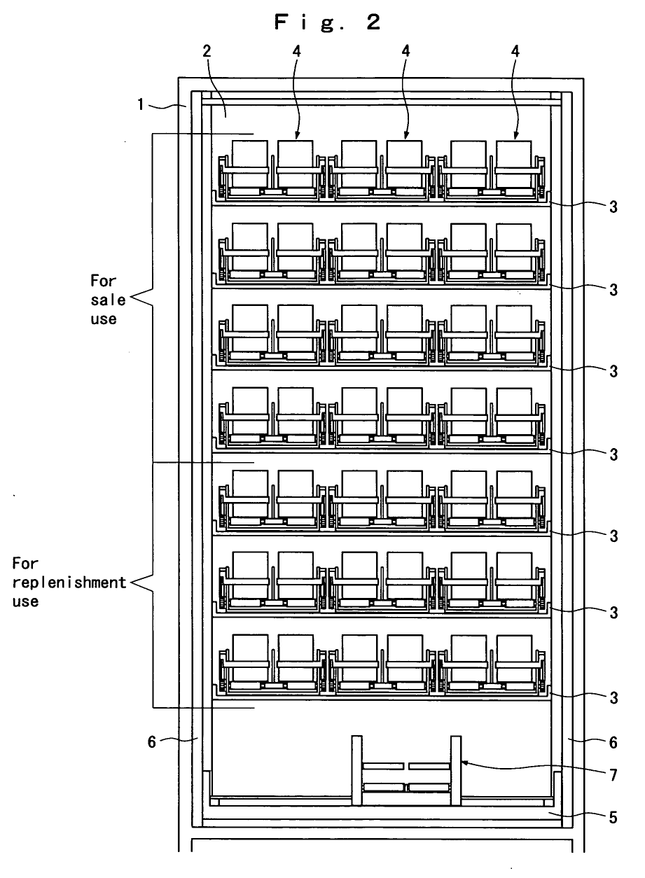

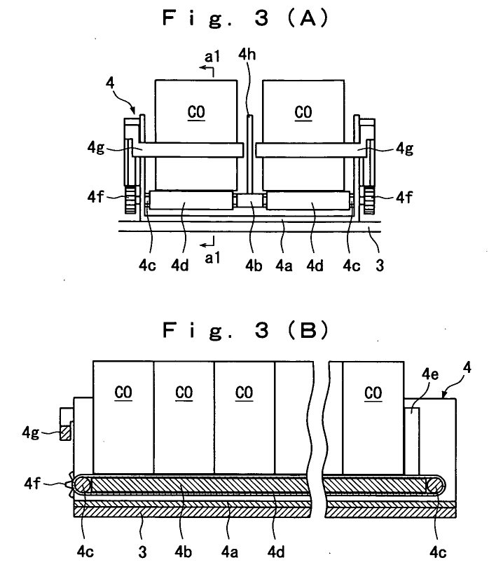

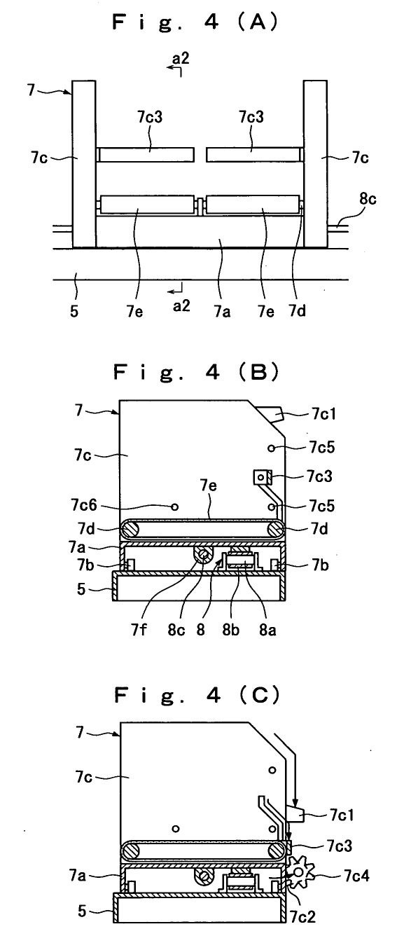

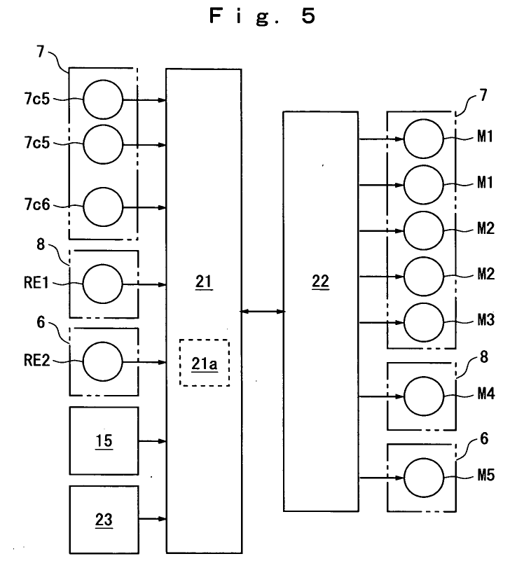

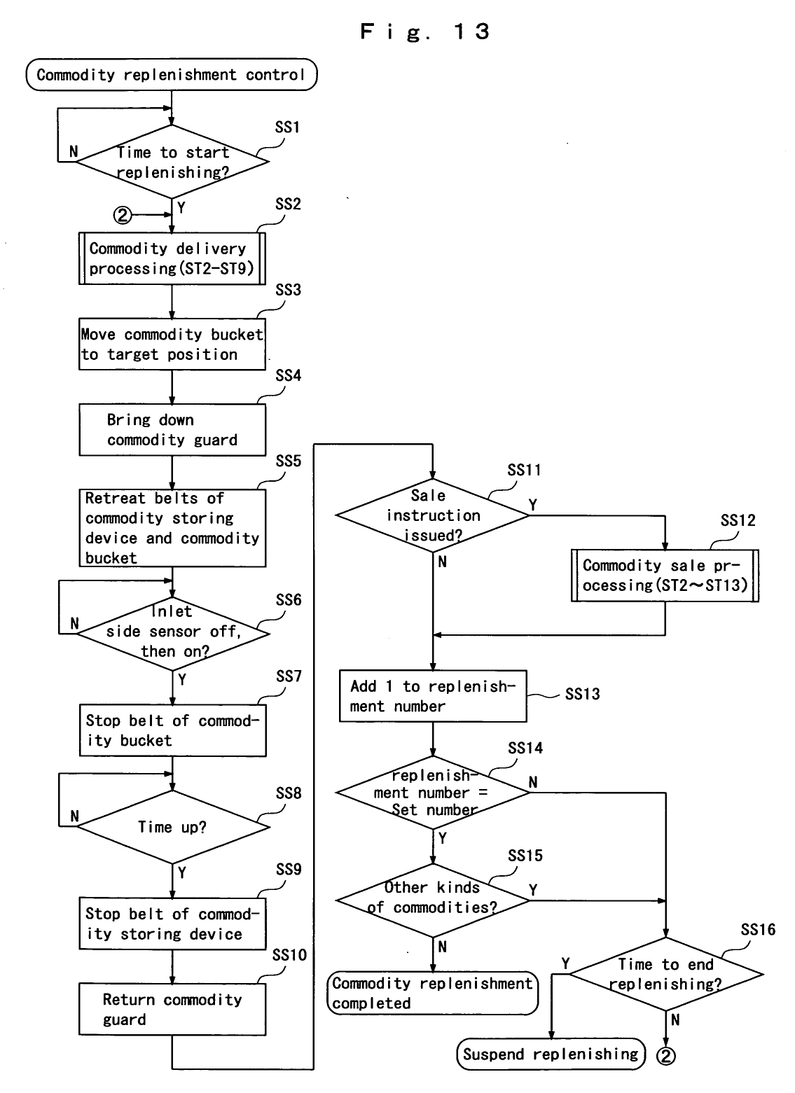

FIG. 1 shows a front view of a vending machine; FIG. 2 shows a front view of a cabinet, revealing the internal mechanism of the vending machine shown in FIG. 1; FIG. 3(A) shows a front view of a commodity storing device shown in FIG. 1 and FIG. 2; FIG. 3(B) shows a section along line a1-a1 in FIG. 3(A); FIG. 4 (A) shows a front view of a commodity bucket shown in FIG. 1 and FIG. 2; FIG. 4(B) shows a section along line a2-a2 in FIG. 4(A); FIG. 4(C) illustrates an operation of the commodity bucket; FIG. 5 shows a configuration of a control system; FIG. 6 is a flow chart of a commodity sale control; FIG. 7 to FIG. 12 illustrate commodity selling actions; FIG. 13 is a flow chart of a commodity replenishment control; FIG. 14 to FIG. 18 illustrate commodity replenishing actions.

To begin with, the mechanical configuration of the vending machine will be described with reference to FIG. 1 to FIG. 4(C).

As shown in FIG. 2, a cabinet 1 has a thermally insulated chamber 2 whose front side is open, and a machinery chamber (not shown) is arranged underneath the chamber 2. Seven shelves 3 are fitted in the chamber 2 another at intervals in a up-and-down direction, and three commodity storing devices 4 are arranged on each of the shelves 3 in a right-and-left direction. Thus in the chamber 2, the commodity storing devices 4 are arranged in a 3×7 matrix form. In their arrangement within the chamber 2, the right and left ends of each of the shelves 3 are engaged with hooks (not shown) provided on or screwed onto the right and left inner faces of the chamber 2.

In front of the shelves 3, there is arranged an elevator 5, and first bucket drive mechanisms 6 for moving the elevator 5 in a up-and-down direction in the chamber 2 provided on the right and left sides of the chamber 2. Further, a commodity bucket 7 is provided on the elevator 5, and the elevator 5 is equipped with a second bucket drive mechanism 8 (see FIG. 4(B)) for moving the commodity bucket 7 in the right-and-left direction on the elevator 5.

Though not shown, an evaporator, a heater and a fan for cooling or heating commodities are provided in the chamber 2, and the machinery chamber accommodates, together with the evaporator, a compressor, a condenser and so forth which constitute a refrigerating plant.

As shown in FIG. 1, a main door 11 is openably fitted to close the front opening of the cabinet 1. A substantially rectangular opening 11a is formed at the upper part of the front face of the main door 11, and a transparent panel 12 made of glass, plastic or the like is attached to the opening 11a. Also on the front face of the main door 11, there are disposed a display device 13 consisting of an LCD or the like, a paper money slot 14, a set of commodity selection buttons 15, a lever 16 for operating the main door lock, a coin slot 17, a coin return lever 18, a coin return pocket 19 and a commodity delivery outlet 20.

As shown in FIGS. 3(A) and 3(B), each commodity storing device 4 is provided with a frame 4a having a substantially U-shaped section; a belt guide plate 4b mounted inside the frame 4a; two sets, front and rear, of abreast-paired shafts 4c rotatably disposed at the front and rear ends of the frame 4a and the belt guide plate 4b; endless belts 4d wound around each front or rear pair of shafts 4c and the belt guide plate 4b; a conveyance assisting plate 4e attached to each belt 4d; follower gears 4f fitted to the two ends of the front shafts 4c; a vertically movable commodity guard 4g arranged in an upper part in front of the belts 4d in a state of being urged upward by coil springs; and a partition 4h detachably attached to the center of the upper face of the belt guide plate 4b.

The commodity storing devices 4 have no power source for individually driving the belts 4d, which instead can move in a back-and-forth direction when a rotational force is transmitted from a drive gear 7c4 of the commodity bucket 7 to the follower gears 4f as will be described in further detail afterwards. Commodities CO, which may be paper-packaged or canned beverages, can be loaded in tandem on the belts 4d of each commodity storing device 4, and the conveyance assisting plate 4e serves to support the rearmost one of the commodities CO. Where mutually different commodities CO are to be loaded on the belts 4d of the commodity storing devices 4, each belt 4d constitutes a commodity storing device in the terminology of claims.

Of course, by removing the partition 4h, it is made possible to load commodities having a greater width on two belts 4d together and to deliver them one by one by the forward movement of the two belts 4d. In this case, the two belts 4d constitute a commodity storing device in the terminology of claims.

The commodity storing devices 4 are separated in the up-and-down direction, and are differentiated into for sale use and for replenishment use. In this embodiment, a total of twenty-one commodity storing devices 4 are arranged in seven tiers in the up-and-down direction, and twelve commodity storing devices 4 arranged on the upper four tiers can be used for sale and nine commodity storing devices 4 arranged on the lower three tiers can be used for replenishment. Thus, by separating the commodity storing devices 4 in the up-and-down direction, the commodity storing devices 4 for sale use and the commodity storing devices 4 for replenishment use are allocated. Commodities CO of the same kind are stored in the commodity storing devices 4 for sale use and the commodity storing devices 4 for replenishment use, and the commodity storing devices 4 for sale use are replenished with commodities CO from the commodity storing devices 4 for replenishment use by a replenishment operation to be described afterwards.

As is seen from FIG. 1, the transparent panel 12 has a size matching the twelve commodity storing devices 4 for sale use arranged on the upper four tiers and is disposed only in front of these commodity storing devices 4. This transparent panel 12 permits visual recognition from outside of the commodities CO stored in the twelve commodity storing devices 4. Thus, the nine commodity storing devices 4 for replenishment use arranged on the lower three tiers are covered by the main door, and are invisible from outside.

As shown in FIGS. 4(A) to 4(C), the commodity bucket 7 has a bottom plate 7a; a plurality of rollers 7b for movement abreast, disposed on the bottom plate 7a; two drive units 7c attached to the right and left of the bottom plate 7a; a pair of shafts 7d, front and rear, installed between the drive units 7c; and two endless belts 7e, right and left, wound around the front-and-rear pair of shafts 7d. Also, a guide bush 7f into which a guide rod 8c, to be described afterwards, is inserted is provided inside the bottom plate 7a.

Each of the drive units 7c is provided inside with a first motor M1 (see FIG. 5) and a gear mechanism (not shown) for moving a press-down lever 7c1, a link arm 7c2 and a commodity guard 7c3 at the same time, and is also provided inside with a second motor M2 (see FIG. 5) and a gear mechanism (not shown) for rotating a drive gear 7c4 provided on the link arm 7c2. Further, one of the drive units 7c is provided inside with a third motor M3 (see FIG. 5) and a gear mechanism (not shown) for moving the two belts 7e by rotating one of the pair of shafts 7d.

Further, one of the drive units 7c is provided within the rear side with one of a light projector and a light receiver constituting two inlet side sensors 7c5 for detecting the position of the commodity CO, and the other drive unit 7c is provided with the other of the light projector and the light receiver. One of the drive units 7c is provided inside the front with one of a light projector and a light receiver constituting outlet side sensors 7c6 for detecting the position of a commodity G, and the other drive unit 7c is provided with the other of the light projector and the light receiver.

The second motor M2 and the gear mechanism for rotating the drive gear 7c4 in each of the drive units 7c constitute a first belt drive mechanism capable of moving the belts 4d of a prescribed commodity storing device 4 in the back-and-forth direction. The third motor M3 and the gear mechanism for rotating one of the pair of shafts 7d constitute a second belt drive mechanism capable of moving the belts 7e of the commodity bucket 7 in the back-and-forth direction.

The second bucket drive mechanism 8, as shown in FIG. 4(B), has a pair of shafts 8a, right and left, provided on the elevator 5; an endless belt 8b wound around the pair of shafts 8a, right and left, a guide rod 8c installed in the abreast direction on the elevator 5; a motor M4 (see FIG. 5) transmitting a rotational force to one of the shafts 8a; and a rotary encoder RE1 (see FIG. 5) for detecting the angle of revolution of the motor M4. A mechanism in which a nut engaging with a motor-driven ball screw, which is disposed on the elevator 5, is linked to the commodity bucket 7 can also be used as this second bucket drive mechanism 8.

Incidentally, the commodity bucket 7, its bottom plate 7a is fastened to a part of the belt 8b, the guide bush 7f in its bottom plate 7a is engaged with the guide rod 8c, and its rollers 7b are in contact with the upper face of the elevator 5.

The first bucket drive mechanisms 6 has two endless chains (not shown) linked in a part to the right and left ends of the elevator 5; gears (not shown) of which two each are arranged in the upper and lower parts of the mechanisms and around each of which a chain is wound; a balance weight (not shown) attached to a part of each chain; rods (not shown) arranged in the upper and lower parts of the mechanisms and each linking two gears, right and left; a motor M5 (see FIG. 5) transmitting a rotational force to one of the rods; and a rotary encoder RE2 (see FIG. 5) for detecting the angle of revolution of the motor M5. As the first bucket drive mechanisms 6, mechanisms in which two endless chains are wound around upper and lower gears can also be used, with the balance weight 6c being excluded.

Incidentally, the first bucket drive mechanism 6 and the second bucket drive mechanism 8 together constitute a commodity bucket drive mechanism capable of moving the commodity bucket 7 in the up-and-down direction and the right-and-left direction. Also, this commodity bucket drive mechanism, the first belt drive mechanism comprising the second motor M2 and the gear mechanism, the commodity bucket 7 having the belts 7e, and the second belt drive mechanism comprising the third motor M3 and the gear mechanism constitute a commodity transferring device for receiving a commodity CO from a prescribed commodity storing device 4 and delivering it to the commodity outlet.

Now will be described the configuration of the control system of the vending machine with reference to FIG. 5.

In FIG. 5, reference numeral 21 denotes a microcomputer-based control unit; 21a denotes a memory of the control unit 21; 22 denotes a motor drive unit; 23 denotes a money handling unit; 7c5 denotes the inlet side sensor of the commodity bucket 7; 7c6 denotes the outlet side sensor of the commodity bucket 7; 15 denotes the set of commodity selection buttons; RE1 denotes the rotary encoder for the second bucket drive mechanism 8; and RE2 denotes the rotary encoder for the first bucket drive mechanism 6.

The memory 21a of the control unit 21 stores, in addition to programs regarding a sale operation and a replenishment operation be described afterwards, the time schedule of commodity replenishment, positional data on each commodity storing device 4 and so forth. The motor drive unit 22 supplies the first to third motors M1 to M3 of the commodity bucket 7, the motor M5 of the first bucket drive mechanism 6 and the motor M4 of the second bucket drive mechanism 8 with respectively predetermined powers on the basis of control signals from the control unit 21.

The money handling unit 23, comprising the aforementioned paper money slot 14, coin slot 17, coin return lever 18 and coin return pocket 19, determines whether any paper money or coin put into the paper money slot 14 and/or the coin slot 17 is true or false, sends to the control unit 21 a signal regarding the sum of money put in, stores true coin or paper money and pays the change, if any.

Next, the sale operation of the vending machine will be described with reference to FIG. 6 to FIG. 12.

The prospective buyer sees through the transparent panel 12 of the main door 11 to look at commodities CO stored in the commodity storing devices 4, decides which commodity CO to buy, puts paper money and/or coin(s) of a sum not less than the price of the commodity into the paper money slot 14 and/or the coin slot 17, and presses the commodity selection button 15 matching the selected commodity CO.

When the control unit 21 issues a selling instruction on the basis of the actions stated above, the destination (delivery target position) of the commodity bucket 7 is determined according to the positional data of the commodity storing devices 4 for sale use stored in the memory 21a. After the delivery target position is determined, as shown in FIG. 7, the commodity bucket 7 in a standby position is moved to the delivery target position by actions the first bucket drive mechanism 6 and the actions of the second bucket drive mechanism 8. This causes the commodity bucket 7 and the commodity storing device 4 to face each other in such a position as the heights of the upper faces of their respective belts 7e and 4d are about equal (steps ST1 and ST2 in FIG. 6).

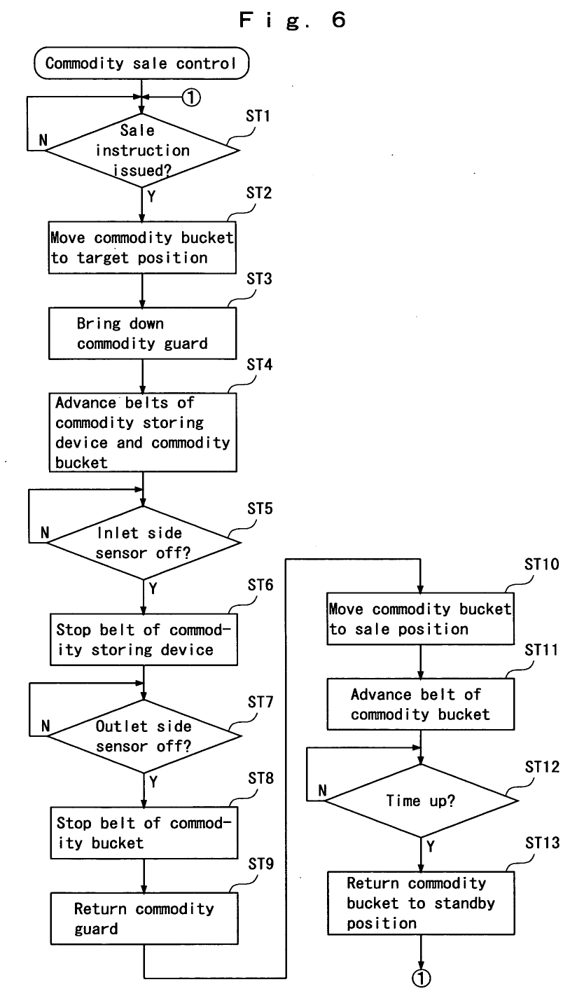

When the commodity bucket 7 was moved to the delivery target position, as shown in FIG. 8, the motor M1 of one of the drive units 7c of the commodity bucket 7 is actuated to displace the press-down lever 7c1, the link arm 7c2 and the commodity guard 7c3 from their respective standby positions to commodity delivering positions (step ST3 in FIG. 6).

In further detail, the press-down lever 7c1 descends from its standby position to press down one of the commodity guard 4g of the commodity storing device 4 against the urging force of the spring, and the commodity guard 4g is inserted into the gap between the belt 4d of the commodity storing device 4 and the belt 7e of the commodity bucket 7. Also, the link arm 7c2 protrudes backward from its standby position, and the drive gear 7c4 engages with one of the follower gears 4f of the commodity storing device 4. Further, the commodity guard 7c3 descends from its standby position to be inserted into the gap between the belt 4d of the commodity storing device 4 and the belt 7e of the commodity bucket 7.

When the descents of the commodity guards 4g and 7c3 are completed, as shown in FIG. 9, the motor M2 of one of the drive units 7c of the commodity bucket 7 is actuated to turn the drive gear 7c4, and this rotational force is transmitted to one of the follower gears 4f of the commodity storing device 4 to turn one of the belt 4d in the forward direction. At the same time, the motor M3 of the commodity bucket 7 is actuated to turn the two belts 7e in the forward direction. This causes the foremost commodity CO on the belt 4d of the commodity storing device 4 to access the belts 7e of the commodity bucket 7 (step ST4 in FIG. 6).

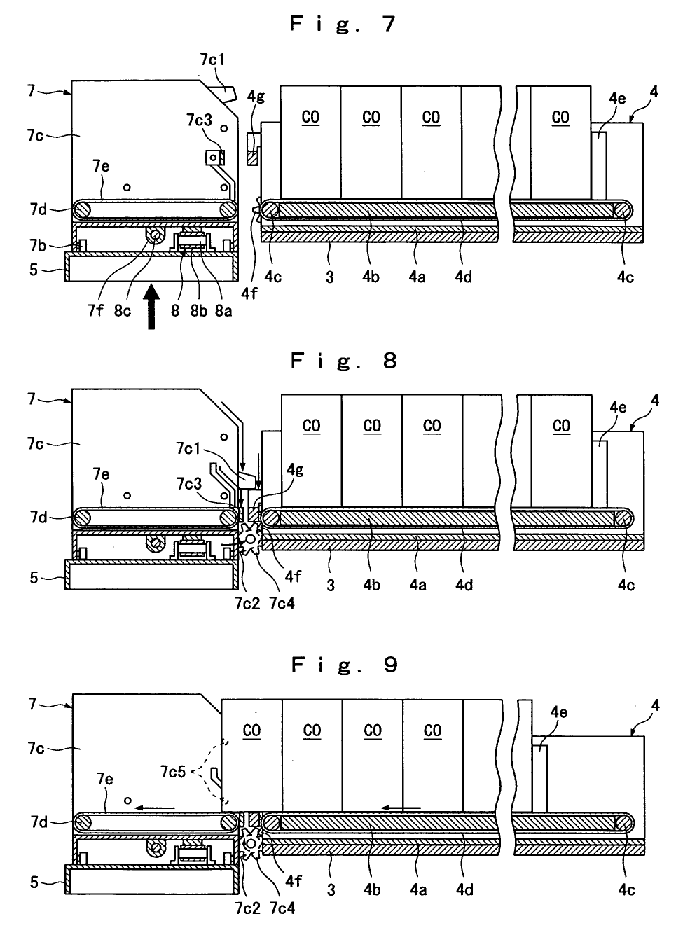

When the commodity CO having accessed the belts 7e of the commodity bucket 7 causes the inlet side sensor 7c5 of the commodity bucket 7 to be turned off, the second motor M2 of one of the drive units 7c of the commodity bucket 7 is stopped, and the belt 4d of the commodity storing device 4 is stopped. As the belts 7e of the commodity bucket 7 keep on running forward even though the belt 4d of the commodity storing device 4 are stopped, the commodity CO having accessed the belts 7e is fully positioned on the belts 7e as shown in FIG. 10 (steps ST5 and ST6 in FIG. 6). Further, when the commodity CO fully positioned on the belts 7e of the commodity bucket 7 causes the outlet side sensor 7c6 of the commodity bucket 7 to be turned off, the third motor M3 of the commodity bucket 7 is stopped, and the belts 7e of the commodity bucket 7 are stopped (steps ST7 and ST8 in FIG. 6).

When the belts 7e of the commodity bucket 7 are stopped, as shown in FIG. 11, the motor M1 of one of the drive units 7c of the commodity bucket 7 is caused to turn in the direction reverse to the above-stated, and the press-down lever 7c1, the link arm 7c2 and the commodity guard 7c3 return to their respective prior positions. The commodity guard 4g of the commodity storing device 4 also returns to its prior position by the urging force of the coil spring (step ST9 in FIG. 6).

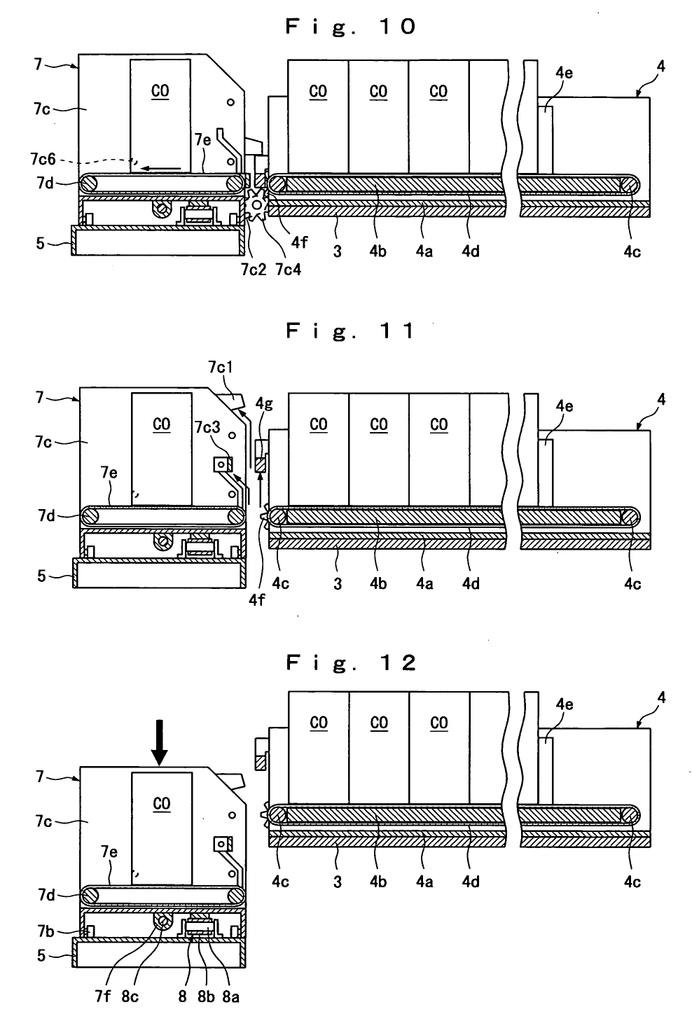

When the delivery of the commodity CO into the commodity bucket 7 is completed, the commodity sale position stored in the memory 21a is read out and, after it has been read out, the commodity bucket 7 in the delivery target position is moved to its commodity sale position by actions of the first bucket drive mechanism 6 and the second bucket drive mechanism 8 as shown in FIG. 12 (step ST10 in FIG. 6).

When the movement of the commodity bucket 7 to the commodity sale position is completed, the third motor M3 of the commodity bucket 7 runs for a predetermined duration to turn both belts 7e forward, and the commodity CO on the belts 7e is delivered out toward the commodity delivery outlet 20 (step ST11 and ST12 in FIG. 6).

When the delivery of the commodity CO out to the commodity outlet 20 is completed, the standby position stored in the memory 21a is read out and, after it has been read out, the commodity bucket 7 in the commodity sale position is moved toward its standby position by actions of the first bucket drive mechanism 6 and the second bucket drive mechanism 8 (step ST13 in FIG. 6).

In order to perform accurately the commodity replenishment to be described afterwards, every time the sale operation is completed, sold numbers corresponding to each kind of commodities CO (each of the commodity storing devices 4 for sale use) are stored in the memory 21a.

Next, the replenishment operation of the vending machine will be described with reference to FIG. 13 to FIG. 18.

The replenishment operation to the commodity storing devices 4 for sale use from the commodity storing devices 4 for replenishment use is basically performed in accordance with a time schedule predetermined in consideration of periods in which the vending machine is used relatively infrequently. For instance, if the vending machine is installed in a school, periods of less frequent use such as class hours and a time period from after-school to before-school are selected as the periods for the replenishment operation. The replenishment operation is accomplished during such replenishment periods by replenishing the commodity storing devices 4 for sale use with at least one commodity corresponding to the each sold number from the commodity storing devices 4 for replenishment use.

When the start time of the replenishment period prescribed by the time schedule comes, the sold numbers corresponding to each of commodities by this time are read out from the memory 21a, and these sold numbers are determined as set replenishment numbers corresponding to each kind of commodities CO (each of the commodity storing devices 4 for sale use). More specifically, the set replenishment number may be set to five for commodity A and three for commodity B, for instance, and the replenishment operation is successively performed on this basis for each kind of commodities.

This replenishment operation begins with commodity delivery processing of steps ST2 to ST9 in FIG. 6 to the commodity storing devices 4 for replenishment use.

When the delivery of the commodity CO into the commodity bucket 7 is completed, the destination (replenishment target position) of the commodity bucket 7 is determined according to the positional data of the commodity storing devices 4 for replenishment use stored in the memory 21a. After the replenishment target position is determined, as shown in FIG. 14, the commodity bucket 7 in the delivery target position is moved toward the replenishment target position by actions of the first bucket drive mechanism 6 and the second bucket drive mechanism 8. This causes the commodity bucket 7 and the commodity storing device 4 to face each other in such a position as the heights of the upper faces of their respective belts 7e and 4d are about equal (steps SS1 to SS3 in FIG. 13).

When the commodity bucket 7 was moved to the replenishment target position, as shown in FIG. 15, the motor M1 of one of the drive units 7c of the commodity bucket 7 is actuated to displace the press-down lever 7c1, the link arm 7c2 and the commodity guard 7c3 from their respective standby positions to commodity delivering positions (step SS4 in FIG. 13).

In further detail, the press-down lever 7c1 descends from its standby position to press down one of the commodity guard 4g of the commodity storing device 4 against the urging force of the spring, and the commodity guard 4g is inserted into the gap between the belt 4d of the commodity storing device 4 and the belt 7e of the commodity bucket 7. Also, the link arm 7c2 protrudes backward from its standby position, and the drive gear 7c4 engages with one of the follower gears 4f of the commodity storing device 4. Further, the commodity guard 7c3 descends from its standby position to be inserted into the gap between the belt 4d of the commodity storing device 4 and the belt 7e of the commodity bucket 7.

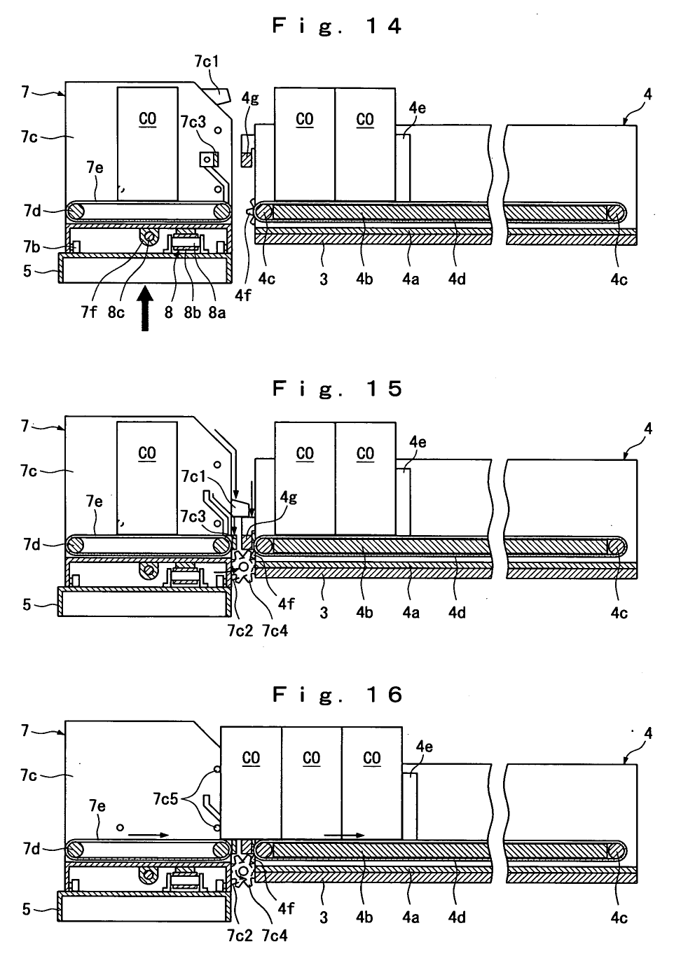

When the descents of the commodity guards 4g and 7c3 are completed, as shown in FIG. 16, the motor M2 of one of the drive units 7c of the commodity bucket 7 is actuated to turn the drive gear 7c4, and this rotational force is transmitted to one of the follower gears 4f of the commodity storing device 4 to turn one of the belt 4d in the backward direction. At the same time, the motor M3 of the commodity bucket 7 is actuated to turn the two belts 7e in the backward direction. This causes the commodity CO on the belts 7e of the commodity bucket 7 to access the belt 4d of the commodity storing device 4 (step SS5 in FIG. 13).

When the commodity CO having accessed the belt 4d of the commodity storing device 4 causes the inlet side sensor 7c5 of the commodity bucket 7 to be once turned off and then turned on, in other words when the commodity CO passes the inlet side sensor 7c5, the third motor M3 of the commodity bucket 7 is stopped, and the belts 7e of the commodity bucket 7 are stopped. As the belt 4d of the commodity storing device 4 keep on running backward even though the belts 7e of the commodity bucket 7 are stopped, the commodity CO having accessed the belt 4d is fully positioned on the belt 4d as shown in FIG. 17 (steps SS6 and SS7 in FIG. 13). Further, a prescribed length of time has passed after the commodity CO passed the inlet side sensor 7c5, the second motor M2 of one of the drive units 7c of the commodity bucket 7 is stopped, and the belt 4d of the commodity storing device 4 is stopped (steps SS8 and SS9 in FIG. 13).

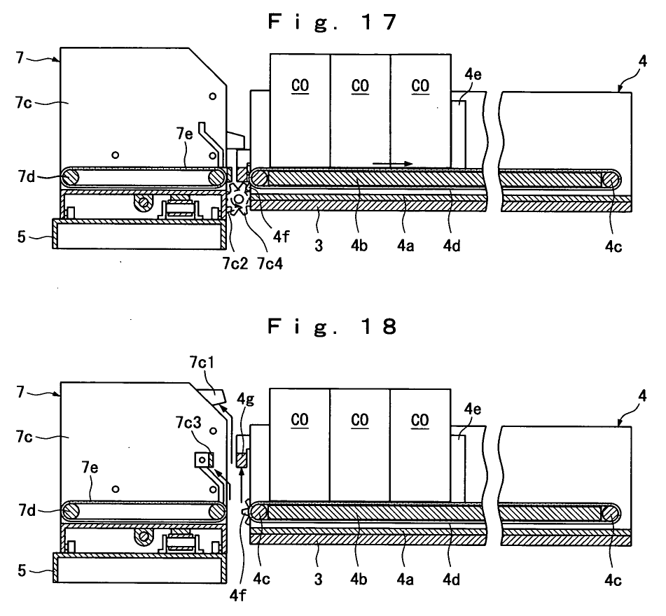

When the belt 4d of the commodity storing device 4 is stopped, as shown in FIG. 18, the motor M1 of one of the drive units 7c of the commodity bucket 7 is caused to turn in the direction reverse to the above-stated, and the press-down lever 7c1, the link arm 7c2 and the commodity guard 7c3 return to their respective prior positions. The commodity guard 4g of the commodity storing device 4 also returns to its prior position by the urging force of the coil spring (step SS10 in FIG. 13).

During the replenishment operation, the issuance of the sale instruction is monitored. When the sale instruction is issued, the replenishment operation is suspended temporarily, and the commodity sale processing of step ST2 to ST13 in FIG. 6 is accomplished by interrupt processing (steps SS11 and SS12 in FIG. 13).

When one round of the replenishment operation was completed for a commodity CO of predetermined kind, one is added to the replenishment number. If the replenishment number is less than the set replenishment number, the same operation to the above-described will be continued by moving over to step SS2. Or if the replenishment number was reached the set replenishment number, it will be checked whether or not there is any other kinds of commodities calling for replenishment. If there is, the same operation to the above-described will be continued for other kinds of commodities by moving over to step SS2 (steps SS13 to SS15 in FIG. 13).

Or if the end time to the replenishment period prescribed by the time schedule comes, even if the replenishment number is not yet reached the set replenishment number or there is other kinds of commodities to be replenished, the replenishment operation will be suspended temporarily (step SS16 in FIG. 13). In this case, though the replenishment operation is suspended, the replenishment operation will be resumed in the next replenishment period on the basis of the set replenishment number to be replenished at the time of resumption.

In the vending machine described above, the commodity storing devices 4 for sale use can be automatically replenished, without relying on manual work, with commodities from the commodity storing devices 4 for replenishment use by means of the commodity transferring device for regular use in selling. Therefore, it is possible to have commodity replenishment follow commodity sale, thereby to prevent the decreased number of commodities CO stored in the commodity storing devices 4 for sale use from deteriorating the impression that the prospective buyer would receive, and accordingly to boost sales by alleviating discouragement on the part of the prospective buyer.

Also, since the commodity replenishment can be accomplished by using the commodity transferring device for regular use in selling, it is unnecessary to provide the installation of another mechanism for use in commodity replenishment, so that it is possible to avoid an increase in cost and vending machine size.

Moreover, since the commodity CO on the belts 7e of the commodity bucket 7 can be moved onto the belt 4d of the commodity storing device 4 for sale use by turning the belt 4d and the belts 7e in the directions reverse to those at the time of selling operation, the replenishment operation to the commodity storing device 4 for sale use can be performed smoothly and reliably.

Furthermore, since the commodity storing devices 4 for sale use and the commodity storing devices 4 for replenishment use are allocated by separating a plurality of commodity storing devices 4, and the transparent panel 12 is disposed in front side of only the commodity storing devices 4 for sale use, the transparent panel 12 can be reduced in size, therefore, a position of the commodity outlet 20 can be freely disposed at the front face of the main door 11.

As in the above embodiment, if a plurality of commodity storing devices 4 are separated in a up-and-down direction, and an upper part of the commodity storing devices 4 are allocated to the commodity storing devices 4 for sale use, it made possible to form the commodity outlet 20 in a high position, thereby, the buyer can easily take out the commodity CO in a standing posture.

Also, since the replenishment operation can be performed in accordance with the predetermined time schedule, the replenishment operation can be efficiently accomplished and prevented from obstructing usual commodity sale if the time schedule is predetermined in consideration of periods in which the vending machine is used relatively infrequently.

Furthermore, since it is possible to suspend the replenishment operation when the sale instruction is issued during the replenishment operation, the sale operation is not obstructed even during the replenishment operation.

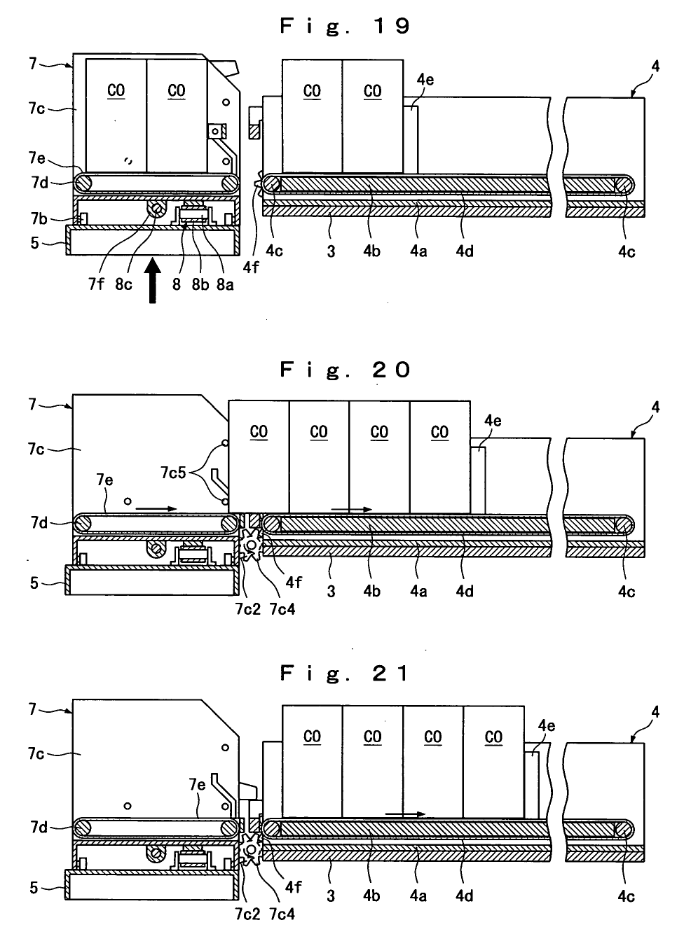

To add, although the commodity storing device 4 for sale use are replenished with one commodity CO at a time from the commodity storing device 4 for replenishment use in the embodiment described above, if two commodities CO are delivered from the commodity storing device 4 for replenishment use onto the belts 7e of the commodity bucket 7 in a single replenishing action as shown in FIG. 19 to FIG. 21, and these two commodities CO are delivered onto the belts 4d of the commodity storing device 4 for sale use, the time taken to replenish commodities can be shortened. Of course, if the commodity size is small enough, the commodity storing devices 4 for sale use can be replenished with three or more commodities in the single replenishing action from the commodity storing device 4 for replenishment use.

Further, though the commodity storing devices 4 for sale use and the commodity storing devices 4 for replenishment use are allocated by separating a plurality of commodity storing devices 4 in the up-and-down direction, and the transparent panel 12 is disposed in front side of only the commodity storing devices 4 for sale use, the upper and lower separating position can be altered as appropriate according to the way in which the commodity storing devices 4 are arrayed or some other factor. Or, even if the commodity storing devices 4 for sale use are positioned on the right or left side and those for replenishment use are on the other side with the transparent panel 12 disposed in front of the commodity storing devices 4 for sale use, the presence of the transparent panel 12 can be prevented from restricting the position in which the commodity outlet 20 is to be formed, enabling the commodity outlet 20 to be formed in a high position.

The preferred embodiments of the present invention so far described in this specification are only illustrative but is not to be taken in a limiting sense. The scope of the invention is stated in the appended claims, and all modifications that can be covered by the claims fall within the scope of the invention.

1. A vending machine comprising:
first commodity storing devices for sale use arranged in the vending machine;
second commodity storing devices for replenishment use arranged in the vending machine;
a commodity transferring device arranged in the vending machine;
a transparent panel arranged on the front face of the vending machine;
a commodity outlet arranged in the front face of the vending machine;
sale control means for delivering a commodity from one of the first commodity storing devices to the commodity outlet by the commodity transferring device; and
replenishment control means for replenishing at least one of the first commodity storing devices with at least one commodity from at least one of the second commodity storing devices by the commodity transferring device.

2. The vending machine according to claim 1, wherein
the first commodity storing devices and the second commodity storing devices are allocated by separating a plurality of commodity storing devices arranged in a matrix form within the vending machine.

3. The vending machine according to claim 2, wherein:
the commodity storing devices are separated in a up-and-down direction.

4. The vending machine according to claim 2, wherein:
the transparent panel is arranged only on the front side of the first commodity storing devices and permits visual recognition from outside of commodities stored in the first commodity storing devices.

5. The vending machine according to claim 1, further comprising:
memory means for storing each sold number of the first commodity storing devices;
wherein the replenishment control means reads out the each sold number from the memory means in accordance with a predetermined time schedule, and replenishes at least one of the first commodity storing devices with at least one commodity corresponding to the each sold number from at least one of the second commodity storing devices.

6. The vending machine according to claim 1, further comprising:
second sale control means for temporarily suspending a replenishment operation when a selling instruction is issued during the replenishment operation, and performing a sale operation corresponding to the selling instruction.

7. The vending machine according to claim 1, wherein:
each of the first commodity storing devices and the second commodity storing devices is provided with a belt which permits loading of a plurality of commodities arranged in tandem and can move in a back-and-forth direction; and
the commodity transferring device includes, a commodity bucket provided with a belt which permits loading of a commodity and can move in the back-and-forth direction, a first belt drive mechanism capable of moving the belt of one of the first commodity storing devices in the back-and-forth direction, a second belt drive mechanism capable of moving the belt of the commodity bucket in the back-and-forth direction, and a bucket drive mechanism capable of moving the commodity bucket in a up-and-down direction and a right-and-left direction.
